(19) United States
(12) Patent Application Publication
(10) Pub. No.: US 2026/0189011 A1
(43) Pub. Date: Jul. 2, 2026

(54) HOME ENERGY MANAGEMENT WITH PREDICTIVE CAPACITOR-BASED LOAD STARTUP CONTROL

(71) Applicant: FORD GLOBAL TECHNOLOGIES, LLC, Dearborn, MI (US)

(72) Inventors: Haider Mhiesan, Canton, MI (US); Timothy Harris, Grosse Ile, MI (US); Kirk Pulay, Belleville, MI (US); Christopher Bernard Trombetta, Commerce Township, MI (US)

(21) Appl. No.: 19/355,366

(22) Filed: Oct. 10, 2025

Related U.S. Application Data
(60) Provisional application No. 63/739,980, filed on Dec. 30, 2024.

(51) Int. Cl. H02J 3/32; H02J 3/007; H02J 7/90

(52) U.S. Cl. CPC H02J 3/322; H02J 3/007; H02J 7/933; H02J 2207/50

(57) ABSTRACT

A home energy management system includes a bus for distributing electrical energy, a switch for selectively coupling a load to the bus, and a capacitor module coupled under control of a controller. The controller charges the capacitor module to a target charge level that corresponds to an expected peak inrush current or energy demand of the load, couples the capacitor module to the bus after the target charge level is reached, and then closes the switch to connect the load while the capacitor module remains engaged. Stored energy from the capacitor module is discharged during startup of the load to support the inrush demand and maintain bus voltage stability until the load reaches steady-state operation.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to control of electrical power flow within an energy system.

### BACKGROUND

A home energy system can distribute electrical power from a utility grid or a local energy source to household loads. An electric vehicle may exchange power with the home energy system through a charging interface.

### SUMMARY

A home energy system includes a bus for distributing electrical energy to one or more loads, a switch for selectively connecting a load to the bus, and a capacitor module that can be coupled to the bus. A controller manages operation by charging the capacitor module to a target charge level, coupling the capacitor module to the bus after the charge level is reached, and then closing the switch so that the load connects to the bus while the capacitor module is engaged. The target charge level corresponds to a peak value of the inrush current associated with startup of the load, such that higher expected peak values result in proportionally higher target charge levels.

A home energy system includes a bus for distributing electrical energy to one or more loads, a switch that selectively connects the loads to the bus, and a capacitor module that can be selectively coupled to the bus. A controller manages operation by charging the capacitor module to a target charge level based at least in part on an expected inrush current associated with a load while the switch remains open, coupling the capacitor module to the bus after the charge level is reached, and then closing the switch so that the load connects to the bus with the capacitor module already engaged. The controller may further prioritize activation of multiple loads according to factors such as load criticality, capacitor charge state, available source energy, or anticipated inrush demand, and may limit the capacitor charge to less than its maximum voltage when appropriate. The system may draw energy from sources such as a utility grid, an electric vehicle, a photovoltaic installation, a stationary battery, or a generator, with an electric vehicle battery connectable through electric vehicle supply equipment in certain embodiments.

A home energy management system includes a capacitor module that can be connected to a bus and a controller that manages operation of the capacitor module. When a request to activate a load is received, the controller charges the capacitor module to a target charge level based on an expected inrush current of the load. The capacitor module is then connected to the bus at the time of load activation so that stored energy is discharged to the bus during the startup interval. The target charge level corresponds to a capacitor voltage sufficient to support the expected peak inrush current of the load.

A home energy management system includes a capacitor module selectively connectable to a bus and a controller that manages charging and discharging of the capacitor module during activation of a load. Upon receiving a request to start a load, the controller charges the capacitor module to a target charge level based at least in part on an expected inrush current associated with that load and then connects the capacitor module to the bus so that stored energy is discharged during the startup interval. The expected inrush current may be determined from a stored load profile, a record of historical operation, manufacturer specifications, or real-time sensor measurements. The controller may verify that the capacitor module has reached the desired charge level prior to authorizing startup, and may adjust the target charge level in real time based on prevailing system conditions. The capacitor module may be housed within the home energy management system or in a separate enclosure, and after supporting the load startup the controller may disconnect the capacitor module and recharge it at a rate that reflects available source energy and pending load requests.

A method of operating a home energy management system includes charging a capacitor module to a target charge level while a load is disconnected from a bus. The target charge level corresponds to an expected peak inrush energy demand associated with the load. After the capacitor module reaches the target charge level, the capacitor module is coupled to the bus, and the load is then coupled to the bus while the capacitor module remains engaged, allowing stored energy to support the load during startup.

A method of operating a home energy management system includes charging a capacitor module to a target charge level based on an expected inrush energy demand associated with a load while the load is disconnected from a bus. After the capacitor module reaches the target charge level, the method includes coupling the capacitor module to the bus and then coupling the load to the bus while the capacitor module remains coupled. The expected inrush demand may be established from a stored load profile, historical startup data, or real-time sensing. The method may further include prioritizing startup of multiple loads based on factors such as load criticality, capacitor charge state, or available source energy, and charging the capacitor to less than its maximum capacity to match the predicted demand. Verification of the charge level may occur prior to activation, and the target charge level may be adjusted dynamically in response to real-time system conditions. In some embodiments, an electric vehicle battery may be coupled to the bus and supply energy to charge the capacitor module during preparation for a load startup.

### BRIEF DESCRIPTION OF THE DRAWINGS

FIG. 1 is a schematic diagram of a home energy system including a flying capacitor and associated components.

FIG. 2 is a schematic diagram of the system of FIG. 1 under normal operating conditions prior to activation of a heavy load.

FIG. 3 is a schematic diagram of the system of FIG. 1 during pre-charging of the flying capacitor in anticipation of a heavy load startup.

FIG. 4 is a schematic diagram of the system of FIG. 1 during startup of a heavy load supported by discharge of the flying capacitor.

FIG. 5 is a schematic diagram of the system of FIG. 1 with the heavy load in steady-state operation and the flying capacitor decoupled.

FIG. 6 is a chart illustrating capacitor voltage, load current, and source current during operation of the system.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electrical energy systems encompass a wide range of configurations used in utility networks, industrial facilities, and residential installations. Such systems manage flows of energy between sources, storage devices, and loads, often across alternating current and direct current domains. Examples include centralized distribution grids, renewable energy systems, backup power supplies, and electric vehicles functioning as distributed resources.

Within residential and commercial contexts, a distributed energy management arrangement may involve an external power source such as a utility grid, one or more local energy sources such as photovoltaic arrays, stationary storage units, or vehicle batteries, and conversion equipment such as inverters, rectifiers, and DC/DC converters. Loads may include appliances, heating and cooling systems, motors, or other electrically powered devices. These elements are interconnected through distribution panels and managed by controllers that govern how and when power is exchanged.

Energy management systems coordinate these interfaces and may direct the flow of energy between external sources, local sources, and connected loads. One form of such a system is a home energy management system (HEMS). A HEMS may be housed in an enclosure that contains power-handling components and a controller, and may be configured to selectively couple to both external power sources, such as the utility grid, and local resources, such as an electric vehicle.

Subsystems within such systems may include switches, relays, capacitors, and power converters arranged to direct and condition energy flow. Loads are often organized through distribution panels, and high-demand loads may be grouped in dedicated panels for coordinated activation. Capacitors may be provided within the HEMS enclosure or as modules connected by switches, forming part of the circuitry that manages transitions between energy sources and loads.

In addition to grid-connected operation, such systems may also operate in an off-grid mode. In this state, the home energy management system may disconnect from the utility grid and maintain power to household loads using local sources. These local sources may include distributed energy resources such as photovoltaic systems, stationary batteries, or vehicle energy storage systems. When a vehicle is connected through bidirectional supply equipment, the traction battery of the vehicle may operate as a source for residential loads, sometimes referred to as vehicle-to-home (V2H) operation. Under such conditions, supervisory control of switching elements, capacitors, and associated circuitry helps coordinate the transition between modes and sustain load operation.

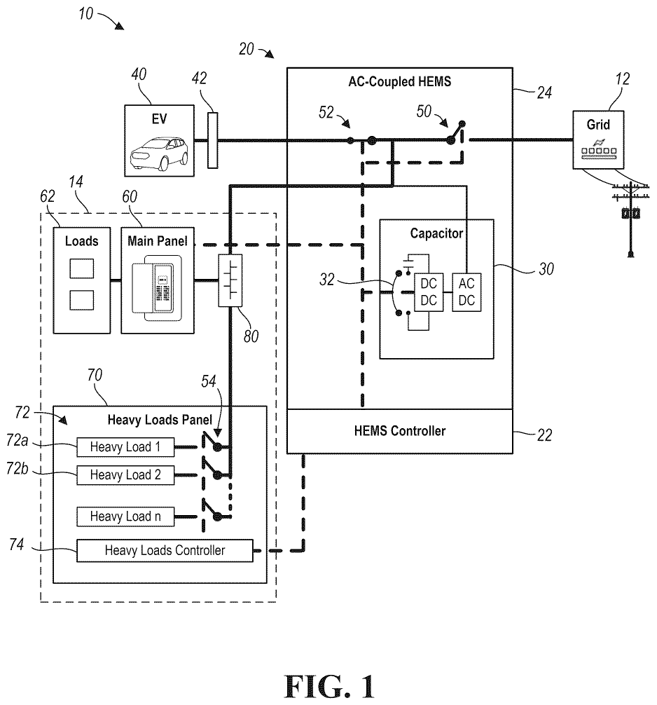

FIG. 1 illustrates a representative home energy system (HES 10) configured to manage the flow of electrical energy between multiple sources and loads. The system includes a grid connection, an electric vehicle interface, and household loads arranged through a main panel and a heavy loads panel. Within an AC-coupled HEMS, components such as relays, controllers, and a capacitor module are shown in schematic form to depict how energy sources and loads are arranged and coordinated.

The HES 10 may couple a home 14 or other building structure to an external power source such as a utility grid 12, a local generator, or another distribution network. The home 14 represents a residential structure or other facility supplied by the HES 10. Within the home 14, electrical loads 62, 72 are shown collectively to represent the various appliances, lighting circuits, climate control equipment, and other devices that consume power. The loads may include both critical loads, which are designated for continued operation during limited-supply or backup conditions, and non-critical loads, which may be curtailed when system resources are constrained.

The utility grid 12 provides an external source of electrical power to the HES 10 and serves as the point of interconnection for importing or exporting energy. The grid 12 may supply power to the home 14 and its loads 62, 72 under normal operating conditions, while also receiving surplus energy discharged from an electric vehicle 40 when bidirectional operation is enabled. In the illustrated embodiment, the grid 12 is connected through the grid relay switch 50, which is open under the depicted mode. The grid 12 may represent a single-phase residential service, a three-phase commercial feed, or a comparable supply.

An electric vehicle (EV) 40 is also connectable as a source, coupled through an electric vehicle supply equipment (EVSE) 42 unit and an EV relay switch 52. The EV 40 may be a battery-electric vehicle, a plug-in hybrid, or another vehicle containing a traction battery that can serve as a source of residential energy.

In some implementations, the EV 40 may include grid-forming inverter capability to establish a local AC reference. In this way, the EV 40 may include an inverter configured to convert DC energy from the traction battery of the EV 40 into AC power. When operating in a grid-forming mode (e.g., in the absence of an external grid signal), the EV 40 may generate a voltage and frequency reference by supplying a synthetic AC waveform.

The EVSE 42 provides an interface between the EV 40 and the HEMS 20, enabling charging of the EV battery and, in some embodiments, bidirectional transfer of power from the EV 40 back into the system 10. The EVSE 42 may be unidirectional, charging only, or bidirectional, capable of supplying power from the vehicle to the home. For example, a bidirectional EVSE 42 may enable vehicle-to-home (V2H) functionality, in which a traction battery of the EV 40 delivers energy into the home energy system 10, or vehicle-to-grid (V2G) functionality, in which the traction battery delivers energy to the grid 12. In some implementations, the EVSE 42 may provide inverter function to establish a local AC reference.

In the configuration shown, the HES 10 is arranged for vehicle-to-home (V2H) operation, with the grid relay switch 50 open and the EV relay switch 52 closed, such that the EV 40 operates as the primary energy source for residential loads. While the illustrated state shows V2H operation, this architecture supports grid-connected operation in which the grid relay switch 50 may be closed and the EV relay switch 52 is either open or closed.

In this way, the electric vehicle 22 and associated EVSE 24 may serve not only as a load during charging operations, but also as a distributed energy resource (DER) capable of supplying power to the home. Other DERs may be integrated into the home energy system 10 to locally generate or store electrical energy for use by a home. As used herein, the term “DER” refers to an on-site or nearby energy source or storage system capable of supplying electrical power to the home. DERs may include photovoltaic (PV) systems that convert solar energy into electrical power, combustion-powered generators configured to produce alternating current (AC) output, stationary batteries that store and discharge energy through power electronic interfaces, and electric vehicles (EVs) equipped with vehicle-to-home (V2H) functionality that enables a traction battery to supply energy back to the home. These DERs may vary in their operating characteristics, such as whether they require synchronization with grid voltage or can operate independently, and whether they interface using direct current (DC) or AC connections.

While the illustrated embodiment of FIG. 1 depicts a single DER in the form of an EV 40, the home energy system 10 may include multiple DERs, with the HEMS controller 22 configured to monitor and coordinate the operation of the multiple DERs. Each DER may be independently connected to the HEMS hub 14 through a dedicated interface—such as an individual relay and sensing circuit—or may be connected through a shared bus. For example, one or more DERs may be connected to the home 14 via an electric service panel 60, a heavy loads panel 70, a home energy gateway, or a local load center. In certain implementations, each DER may be associated with one or more power electronics components (such as inverters, relays, and metering circuits) that condition its electrical output and control its connection to other system components.

While the characteristics of each DER may differ depending on its physical makeup and electrical design, these distributed energy contributors generally share the ability to provide at least some level of localized power to support residential loads 62, 72. In certain embodiments, a DER may be configured to export power to the electric grid or to charge a vehicle or storage system. In other embodiments, a DER may be used primarily for backup power and remain inactive until a loss of grid connectivity is detected. Depending on the system architecture, a home 14 may include a combination of active and standby DERs, with an energy management interface or supervisory logic coordinating their operation based on real-time needs.

A home energy management system (HEMS) 20 provides supervisory control of switching and coordination functions. The HEMS 20, also referred to as a “HEMS hub,” acts as a centralized integration and coordination point for external and local energy resources of the home energy system 10. The HEMS 20 may include, for example, various control, sensing, and switching components configured to evaluate electrical conditions and influence system behavior.

The HEMS 20 includes a HEMS housing 24, which may contain one or more power-handling components, and a HEMS controller 22, which monitors energy availability, capacitor status, and load requests.

The HEMS controller 22 may be implemented as a dedicated microcontroller, a programmable logic controller, or distributed control circuitry. The HEMS controller 22 functions as a supervisory and control layer within the HEMS 20, providing monitoring, decision-making, and actuation capabilities that govern how energy is exchanged among the grid 12, the loads 62, 72, the EV 40, and other system components. The HEMS controller 22 may process input from current and voltage sensors located at various points in the system and produces output signals to adjust active power, control charge or discharge rates, or actuate relays for isolation of devices. In this manner, the HEMS controller 22 supports continuous balance of power flows, mitigation of overcurrent conditions, and coordination of multiple resources operating on a common electrical bus.

More particularly, the HEMS controller 22 is configured to coordinate operation of the system 10 based on measured electrical conditions and predefined control logic. The HEMS controller 22 may include processing hardware, memory, and associated software or firmware instructions enabling it to execute logic routines, reference stored action tables, and initiate control responses. These responses may include controlling relays, influencing load distribution, initiating isolation (e.g., distributed energy resource (DER) or transformer isolation), or communicating with other system components such as DERs or vehicle charging interfaces. The HEMS controller 22 may monitor parameters such as transformer temperature, current draw, and voltage drop, either directly or through associated sensors, and may determine whether one or more predefined values, thresholds, or combinations of conditions are met.

While the HEMS controller 22 is illustrated as being integrated within the HEMS enclosure 24 in FIG. 1, as will be appreciated, the HEMS controller 22 may be positioned elsewhere within or around the home 14, or may be remote from the premises altogether. For example, certain aspects of the control logic may be executed by a cloud-based platform, with the HEMS controller 22 operating as a distributed control system that coordinates local measurements and actions with remote decision-making resources. This flexibility allows the control functions associated with system monitoring and load coordination to be implemented using a variety of hardware topologies, including configurations with centralized, decentralized, or hybrid control architectures.

The HEMS controller 22 may include processing hardware configured to operate in conjunction with a memory storing logic routines, parameter values or thresholds, and other control instructions. The memory may comprise a non-transitory computer-readable medium storing instructions that, when executed by the HEMS controller 22, cause it to perform the control and coordination operations described herein. These operations may include initiating transformer isolation, influencing load distribution, or controlling relays based on measured electrical conditions.

The memory may reside locally within the same housing as the HEMS controller 22, such as within the HEMS enclosure 24, or may be located remotely and accessed via wired or wireless communication. In some implementations, the memory may be cloud-accessible, enabling updates to control logic or threshold values over time. Regardless of location, the memory provides the programmable basis for the system's decision-making capabilities. In this way, upon determining one or more predefined values, thresholds, or combinations of conditions are satisfied, the HEMS controller 22 may initiate actions stored in the memory.

The HEMS controller 22 may serve as a central signaling and control platform, interfacing with other components in system 10 as well as external or remote entities. More particularly, HEMS controller 22 may include or be operatively coupled to a communication interface configured to enable data exchange between the HEMS controller 22 and other system components. For example, the HEMS controller 22 may be communicatively connected to the EVSE 42 to receive operational status, power availability, or charging readiness signals. In embodiments where vehicle state of charge (SOC) data is made available to the system 10, the HEMS controller 22 may receive such information from the EVSE 42 and determine whether to enable or delay charging. The HEMS controller 22 may also coordinate energy flow logic by activating or deactivating system relays in response to changing DER output, vehicle connection status, or homeowner-specified operating modes.

The communication interface may support wired or wireless communication protocols, and may be used to receive updated control logic, action tables, or firmware updates from a cloud-based service. In some implementations, the communication interface also facilitates interaction with a mobile application or utility server. In configurations supporting cloud-based functionality, the communication interface may maintain a data link between the HEMS controller 22 and a remote server environment. This connectivity may allow operational data, such as transformer loading trends, control actions taken, or threshold event histories, to be uploaded for long-term storage, analytics, or diagnostic purposes. In some cases, the cloud platform may support system updates, allowing the HEMS controller 22 to receive revised logic structures or updated firmware.

In some implementations, the HEMS housing 24 may be a unitary housing or enclosure, often referred to as a “combiner box”, that physically houses the major control and power-handling components of the home energy management system 20. This housing 24 may be weatherproof, thermally managed, or segmented to separate high-voltage and low-voltage compartments. The housing 24 includes pass-through or grommeted cable routing for accommodating L1, L2, Neutral, and ground conductors, along with low-voltage wiring for battery connections, control signals, and communications. Internally, the housing 24 may include mechanical structures for mounting and securing components, as well as provisions for electrical interconnection, heat dissipation, and environmental protection. For example, the housing 24 may include one or more compartments, internal mounting rails, or backplanes configured to support components such as the HEMS controller 22, other control circuitry, memory, and communication interfaces. The housing 24 may also house a HEMS inverter and a dark start battery in a compact and coordinated arrangement. Enclosure features may also include printed circuit boards, high-voltage busbars, DC and AC wiring terminals, relays, sensors, fuses, communication ports, and other electronic components for integrating the system into the broader home electrical infrastructure.

In other configurations, components of the HEMS 20 may be physically distributed rather than housed within a single enclosure. For instance, the HEMS controller 22 may be housed in a separate enclosure or located in a different area of the premises. Likewise, a dark start battery or HEMS inverter may be located externally to reduce enclosure size, support user-replaceability, or meet certain thermal or spatial design considerations. In these distributed implementations, the components may be electrically coupled via appropriate wiring harnesses, communication links, or power bus interfaces to maintain integrated system functionality.

The system includes a capacitor module, referred to herein as capacitor 30, that functions as a selectively connectable energy buffer. The capacitor may be in the form of a flying capacitor 30, and the terms may be used interchangeably herein. As used herein, the term “flying capacitor” describes a capacitor that is not permanently tied to a single circuit node but is instead dynamically coupled and decoupled by switching devices. Unlike fixed capacitors that are continuously in parallel with a supply or load, a flying capacitor is placed under active control, allowing its stored charge to be deployed only at selected times and under targeted operating conditions.

In the configuration of FIG. 1, the flying capacitor 30 is connected into the system through a capacitor switch 32, enabling the capacitor 30 to be charged when conditions warrant and discharged into a distribution bus 80 (described in greater detail elsewhere herein) during transient events. The capacitor switch 32 may be an electromechanical relay or contactor that provides galvanic separation when open. In other embodiments, the switch 32 is a semiconductor device such as a MOSFET, IGBT, or a solid-state relay capable of rapid actuation and precise timing. The switch 32 may also be implemented as a combination of devices arranged to coordinate isolation, precharge, and discharge functions. In this way, the switch 32 provides the mechanism through which the capacitor 30 is placed into or removed from electrical communication with the bus 80.

The flying capacitor 30 itself may be, for example, a single capacitor element sized to hold sufficient charge for anticipated load demands, a parallel bank of capacitors combined to achieve a desired energy storage capacity, or a supercapacitor module providing higher specific energy and rapid charge-discharge cycles. Different capacitance and voltage ratings may be selected depending on whether the capacitor 30 is intended to support short-duration motor startups, longer surges, or other system transients.

Placement of the flying capacitor 30 can also vary. In the embodiment of FIG. 1, capacitor 30 is housed within HEMS 20, such as within the HEMS housing 24, where it is directly coordinated by HEMS controller 22. In other embodiments, the capacitor 30 may be located external to the HEMS, such as within a separate module coupled to the distribution bus 80, within an EVSE unit 42, or in proximity to a load panel.

In operation, the flying capacitor 30 serves as a controllable reservoir of electrical energy that can be selectively applied to stabilize bus 80 during demand events such as startup of a heavy load 72. While FIG. 1 shows the capacitor 30 in an open, standby state, the switch 32 can be closed to charge the capacitor 30 in preparation for discharge. Subsequent control logic may determine when and how much energy to release, based on load conditions and system predictions.

The HEMS 20 is coupled downstream to an electric service panel, referred to herein as a main panel 60, which serves as the distribution center for household circuits. The main panel 60 supplies home loads 62, which may include appliances, lighting circuits, and other domestic devices. In some implementations, one or more of the home loads 62 may also function as distributed energy resources, such as a photovoltaic inverter or a battery-backed circuit, capable of supplying energy under certain conditions.

The HEMS 20 is also coupled to a heavy loads panel 70, which is dedicated to heavy loads 72 requiring high inrush currents at startup. In the embodiment shown, two heavy loads 72a and 72b are depicted, though additional loads may be included. Each heavy load 72 is connected through a respective heavy load relay switch 54, which is shown open in the illustrated condition.

Heavy loads 72 differ from typical residential devices in that their initial energization involves a transient demand well above steady-state consumption. Appliances such as resistive heating elements, compressors (e.g., air conditioning compressors), pumps (e.g., water pumps), or other motor-driven equipment may draw an inrush current several times their rated operating current during startup. These transients can persist from fractions of a cycle to several seconds, and they place short-term stress on the available supply. Once operating, such loads 72 consume energy within levels that the HEMS 20 can manage on a steady basis. It is the activation phase, when current demand briefly but substantially exceeds steady-state levels, that creates the distinct operating condition considered in this disclosure.

The heavy loads panel 70 includes a heavy loads controller 74 that manages requests for activation of heavy loads 72. The heavy loads controller 74 communicates with the HEMS controller 22 to request authorization before any heavy load relay switch 54 is closed. The HEMS controller 22 may serve as a higher-level coordination platform, managing homeowner preferences, scheduling inputs, or communications with external entities such as a utility server. The heavy loads controller 74 may perform supervisory monitoring and real-time actuation associated with the energy flows through relays, chargers, and distributed resources. This cooperative configuration and exchange of data between the HEMS controller 22 and heavy loads controller 74 allows for two control layers to balance energy supply and demand in a coordinated manner, enabling sequencing of heavy load activation with preparation of the flying capacitor 30.

In this way, the system 10 includes one or more communication lines that provide a signaling pathway between the HEMS controller 22 and the heavy loads controller 74. The communication pathways between the HEMS controller 22 and the heavy loads controller 74, as well as between the controllers and the various relay switches 50, 52, 54 and capacitor switch 32, are depicted in FIG. 1 as dashed lines. Communication lines may be implemented using any suitable wired (e.g., low-voltage control wiring, serial buses, or power line carrier signaling) or wireless protocol, and may support bi-directional data flow that accommodates system monitoring, coordination of switching events, and transmission of configuration updates. Signals exchanged may include load requests, authorization responses, capacitor charge status, and system state data.

The system 10 further includes a distribution bus 80 coupled downstream of the HEMS 20. The distribution bus 80 serves as a common electrical node at which upstream energy sources converge and from which downstream loads are supplied. In the embodiment shown, energy from grid 12 or EV 40 is directed through the HEMS 20 and delivered onto distribution bus 80. Capacitor 30 is selectively connectable to bus 80 through switch 32 such that stored energy can be applied directly to the bus 80 when commanded by controller 22.

The distribution bus 80 provides a shared supply point for both main panel 60 and heavy loads panel 70. Main panel 60 directs energy from the bus 80 to household loads 62, while heavy loads panel 70 directs energy from the bus 80 to individual heavy loads 72 through relay 54. In this configuration, both steady-state and transient power flows are referenced to the bus 80, and both general and heavy loads see bus 80 as their supply node.

The distribution bus 80 may take the form of a bus bar, a cable harness, a printed circuit conductor, or other suitable distribution component. In some embodiments, bus 80 may be physically housed within the HEMS enclosure 24. In other embodiments, bus 80 may be integrated within main panel 60 or provided as a separate distribution element. In such approaches, the bus 80 functions as the aggregation point for upstream sources and the distribution point for downstream loads.

The distribution bus 80 may also accommodate additional connections. For example, a photovoltaic inverter, stationary battery, or another distributed energy resource may be tied directly to bus 80. Similarly, bidirectional EVSE 42 may be arranged to couple on the bus side of HEMS 20.

Controller 22 may monitor conditions on bus 80, such as bus voltage, frequency, or instantaneous power flow. These measurements may be used to coordinate operation of capacitor 30, authorize closure of relay 54 for heavy loads, or coordinate switching states at relays 50 and 52. In this manner, bus 80 serves not only as the physical supply node for downstream loads, but also as the monitored reference point for HEMS decision-making.

Although FIG. 1 depicts bus 80 in a residential configuration, the same distribution node concept may be applied in larger facilities, microgrid installations, or other energy systems. In such embodiments, bus 80 may interconnect multiple sources and loads across broader distribution levels, while capacitor 30 or other energy-buffering elements are positioned to support transient events referenced to that bus.

The power pathways of FIG. 1 are shown as solid lines, representing the conductors that carry current and voltage between the grid 12, the EV 40, the HEMS 20, the bus 80, the main panel 60, and the heavy loads panel 70. The control pathways are shown as dashed lines, representing supervisory signals exchanged among controllers and switching elements.

During normal operation, the home energy system 10 functions to supply residential demands from whichever source is active. In a grid-connected state, grid relay switch 50 may be closed, with energy delivered from the utility grid 12 through the HEMS 20 to main panel 60 and home loads 62. In the V2H, grid-disconnect state shown in FIG. 1, grid relay switch 50 is open, EV relay switch 52 is closed, and the EV 40 serves as the active source through its associated EVSE 42. In either case, the HEMS 20 coordinates the flow of power to the main panel 60, where it is distributed to general home loads 62. Heavy loads 72 are disconnected in the initial condition, and the system maintains a steady operating state without unusual transients.

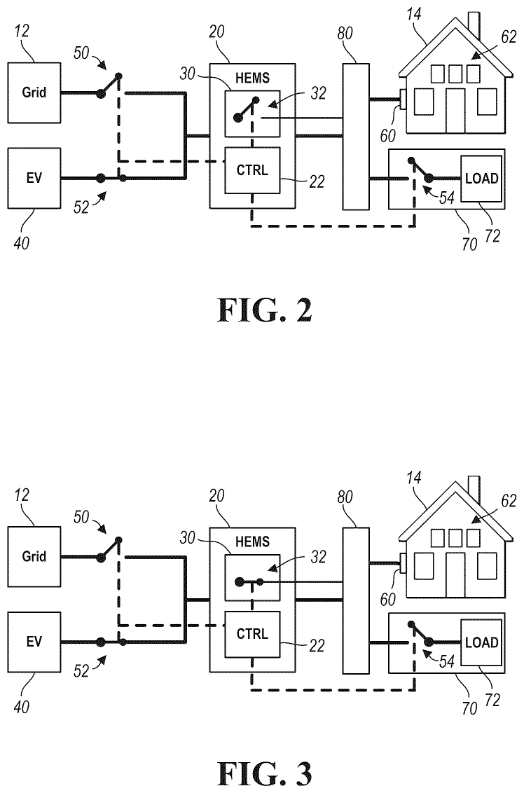

Referring now to FIG. 2, in the operating condition illustrated in which the grid relay switch 50 is open and the EV relay switch 52 is closed, the EV 40 serves as the primary energy source, supplying power through the EVSE 42 into the HEMS 20. The HEMS 20 distributes this power through the bus 80 to home loads 62 via the main panel 60, while the heavy loads panel 70 is disconnected by open relays 54. The flying capacitor 30 remains isolated by open capacitor switch 32. From this condition, the HEMS controller 22 may initiate charging of the capacitor 30 in anticipation of a heavy load request, after which the heavy loads controller 74 may request closure of a heavy load relay 54 for activation of a selected heavy load 72.

The process of initiating a heavy load 72 begins when the HEMS controller 22 receives an indication to activate a particular load. The indication may originate from a heavy loads controller 74 associated with panel 70, from a device-level control (for example, a thermostat or pump controller), from a user interface or schedule, or from monitoring logic executed by the HEMS controller 22 itself. The indication is conveyed over the control pathways shown in FIG. 1 and identifies the load to be activated; it does not energize the load. The HEMS controller 22 evaluates system conditions and coordinates subsequent actions for activation.

The HEMS controller 22 interprets the received indication and determines the particular heavy load 72 that is to be activated. In doing so, the controller 22 identifies not only that a load startup is pending, but also which specific load is requesting activation. Each heavy load 72 can be associated with a demand profile representing expected startup behavior, including the magnitude and duration of inrush current. Such a demand profile may be drawn from a preconfigured database, refined from historical observations of the load, or estimated from real-time electrical sensing. These approaches allow the controller 22 to treat each activation request as a distinct event with a predicted demand characteristic.

At this stage, the system of FIG. 2 remains in a stable condition, supplying home loads 62 from the active source. In one mode, grid relay switch 50 is closed such that the utility grid 12 energizes bus 80. In another mode, grid relay switch 50 is open and EV relay switch 52 is closed such that the electric vehicle 40 provides power through EVSE 42. In either case, capacitor switch 32 is open and heavy load relay switch 54 is open, leaving flying capacitor 30 in a standby state and heavy load 72 unenergized. The startup of a heavy load 72, however, is distinct from steady-state supply of base loads 62. The pending activation introduces a transient surge that may exceed the tolerances of the active source, whether a utility grid with stable but finite fault capacity, or a bidirectional inverter of the electric vehicle 40 with constrained instantaneous output. The HEMS controller 22 therefore recognizes that a transition is forthcoming and prepares for management of the expected inrush.

FIG. 3 illustrates the system during a transition state following the receipt of a heavy load startup request. As described with respect to FIG. 2, the HEMS controller 22 has identified the pending activation of a particular heavy load 72 and associated the request with an expected demand profile. Having determined that the upcoming startup may exceed the steady-state capabilities of the active source, the HEMS controller 22 initiates preparation of the flying capacitor 30. In this condition, the capacitor switch 32 is closed, signifying that the capacitor is to be charged in advance of the load activation event.

With the capacitor switch 32 closed, the flying capacitor 30 is electrically coupled to the supply bus 80. Energy from the active source flows into the capacitor 30, establishing it as a temporary energy reservoir. If the grid relay switch 50 is closed, the capacitor 30 is charged from the utility grid 12; if the EV relay switch 52 is closed, the capacitor 30 is charged from the electric vehicle 40. This operation differs from a permanently connected capacitor, which would always remain charged to the maximum available voltage. Instead, the capacitor 30 here is selectively charged in response to a predicted need, under direct control of the HEMS controller 22.

The charging phase shown in FIG. 3 is carried out in a controlled manner. The HEMS controller 22 determines a target charge level based on the anticipated inrush demand of the heavy load 72. Rather than indiscriminately filling the capacitor 30 to its maximum capacity, the controller 22 may direct charging to a voltage corresponding to the expected transient. For example, the capacitor 30 may be charged to supply energy sufficient for the brief startup of a pump or compressor, without unnecessarily storing energy beyond what the predicted event requires. This selective charging supports dynamic operation of the system 10, preparing the capacitor 30 specifically for the load that is about to be energized.

In determining how much energy to store in the capacitor 30, the HEMS controller 22 may rely on several types of predictive information. In one implementation, the controller 22 references a preconfigured database in which individual heavy loads 72 are mapped to known startup profiles. In another, the controller 22 draws on historical data, having logged past activations of the same load and refined its estimates of surge magnitude and duration. In still another, the controller 22 may estimate demand by measuring electrical characteristics of the load in real time, such as impedance or instantaneous current behavior. These approaches may be used individually or in combination.

During this charging interval, the active source continues to power home loads 62 through the main panel 60, maintaining base supply conditions. The charging of capacitor 30 represents an additional demand, but the HEMS controller 22 may control the rate of charging so as not to disturb the system 10. For instance, the controller 22 may limit the rate of energy transfer into the capacitor 30, or may stagger charging intervals to minimize interference with other operating loads.

While the capacitor 30 is being charged, other system components may remain in their inactive positions. The heavy load relay switch 54 is held open, leaving heavy load 72 unenergized. The grid relay switch 50 and EV relay switch 52 remain in their prior positions depending on which source is active. Control pathways remain engaged, with communication continuing between HEMS controller 22 and heavy loads panel 70, or between HEMS controller 22 and device-level logic, confirming that the heavy load startup is pending but not yet authorized. In this way, the system remains stable while entering a preparation state.

The role of the flying capacitor 30 in this condition is to act as a selectively available energy buffer. Its purpose is not to provide continuous operation of the heavy load 72, but to absorb the front edge of the startup transient that the source alone may not comfortably supply. This distinguishes the capacitor 30 from conventional approaches, such as pre-charge resistors or permanently connected bus capacitors. For example, the flying capacitor 30 may be activated only when commanded, charged only to the level needed for the upcoming event, and held in readiness until the moment of load engagement.

Once the capacitor 30 is charged to the target level, the system 10 is prepared to proceed to the next phase. At this point, the HEMS controller 22 can authorize closure of the heavy load relay switch 54.

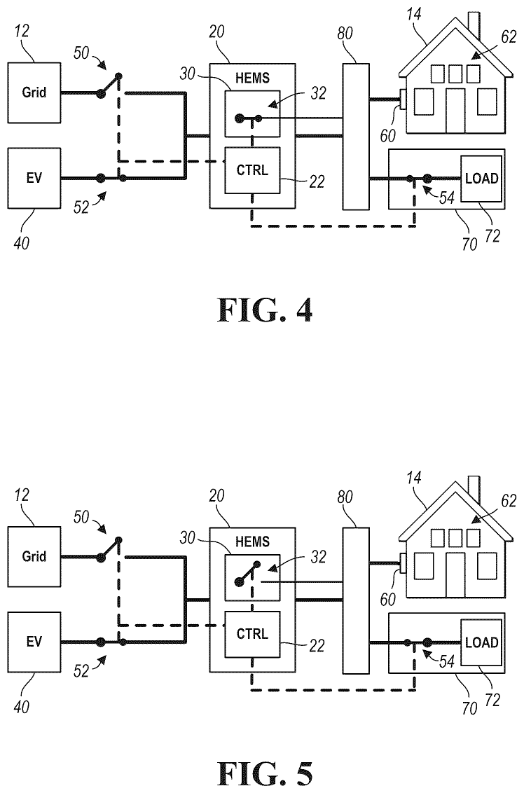

FIG. 4 illustrates the system at the moment when the heavy load 72 is energized and the capacitor 30 discharges into bus 80, supplementing the source to accommodate the inrush demand. In the prior state shown in FIG. 3, the flying capacitor 30 was pre-charged to a level determined by the HEMS controller 22 in anticipation of the startup event. At the transition to FIG. 4, the HEMS controller 22 issues a command to close the heavy load relay switch 54, connecting the heavy load 72 to the bus 80. This action marks the initiation of the startup phase, during which the pre-charged capacitor 30 is placed into service.

When the heavy load relay switch 54 closes, the heavy load 72 is electrically coupled to the system bus 80. The immediate result is a sharp surge in current demand, sometimes referred to as inrush current. This surge arises because devices such as compressors, pumps, and other motor-driven loads require a brief but substantial current draw to overcome inertia and establish normal operation. If supplied directly by the active source alone, such inrush can momentarily depress bus voltage or cause the source to exceed its rated output capability.

To mitigate this effect, the flying capacitor switch 32 remains closed, maintaining the charged capacitor 30 in circuit with the bus 80. At the instant the heavy load relay switch 54 engages, the capacitor 30 begins to discharge into the bus 80. The stored energy flows into the circuit in parallel with the contribution of the active source, effectively supplementing the grid 12 or the electric vehicle 40 during the brief but demanding startup interval. This coordinated discharge ensures that the heavy load 72 receives sufficient energy without forcing the source alone to absorb the entire transient.

The interaction between the capacitor 30 and the active source is complementary. The grid 12, when connected through relay switch 50, continues to provide its steady, voltage-monitored output, while the capacitor 30 delivers the burst of current needed at startup. When the source is the electric vehicle 40, connected through EV relay switch 52, the capacitor 30 supports the vehicle inverter by supplying the high transient demand that could otherwise stress inverter switching devices or battery discharge rates. In both cases, the bus 80 remains stable, and voltage supplied to home loads 62 and other circuits downstream of main panel 60 is not significantly disturbed by the activation of heavy load 72.

The operational role of the flying capacitor 30 in FIG. 4 contrasts with conventional capacitor arrangements. Permanently connected capacitors, which may be present in inverter circuits, maintain a continuous charge but are not dynamically adjusted for particular startup events. Pre-charge circuits with resistors may be used to moderate inrush when connecting a load, but they do not actively discharge into the load to assist with startup. The configuration shown in FIG. 4 provides selective charging of the capacitor 30 to a tailored level, followed by deliberate discharge coinciding with the moment of load activation.

Throughout this process, other elements of the home energy system 10 remain in their established positions. The system 10 continues to draw from either the grid 12 or the electric vehicle 40 as its primary source, and home loads 62 remain energized without interruption through main panel 60. The HEMS controller 22 continues to monitor system voltage, capacitor state, and load behavior via the control pathways.

As the heavy load 72 transitions from its inrush period to steady-state operation, current demand decreases to a level that can be comfortably met by the active source alone. At this point, the capacitor 30 has discharged a substantial portion of its stored energy. The HEMS controller 22 recognizes that the transient interval has ended and prepares to open the capacitor switch 32. In doing so, the capacitor 30 is returned to standby, and a recharge sequence may be initiated in preparation for future load activations.

FIG. 5 illustrates the system during steady-state operation following activation of a heavy load 72, in which the heavy load 72 is running steadily while the capacitor 30 is decoupled and restored to readiness. In the preceding interval, the flying capacitor 30 provided supplemental energy to cover the initial surge of inrush current. With that transient phase now complete, the heavy load 72 has transitioned into a stable operating condition. The bus 80 is supplied primarily by the active source (e.g., the grid 12 through grid relay switch 50, or the electric vehicle 40 through EV relay switch 52). The capacitor 30 has discharged a portion of its stored energy and is no longer required to support the system at this stage.

The heavy load 72 now draws current at a steady, predictable rate consistent with its rated operation. For example, a motor-driven compressor that required several hundred joules during startup may now operate continuously at a fraction of that demand. This level of consumption is within the capacity of the grid 12, the electric vehicle 40, or another distributed source coupled to the home energy system 10. Home loads 62 connected through main panel 60 continue to be supplied in parallel, without interruption or observable fluctuation in voltage. The system 10 has therefore stabilized into a normal operating mode, in contrast to the transient behavior during startup.

To reflect this change in conditions, the HEMS controller 22 opens the capacitor switch 32, decoupling the flying capacitor 30 from the bus 80. Once disconnected, the capacitor 30 is placed into a standby state. This selective removal prevents unnecessary cycling of the capacitor 30 and minimizes its exposure to continuous operating currents that are more efficiently supplied by the primary source. The system 10 thereby retains the capacitor 30 as a reserved buffer, available for future transient events rather than being consumed by steady-state flow.

After discharge, the voltage of the capacitor 30 is lower than its pre-charge level, and the HEMS controller 22 initiates a recharge sequence. The controller 30 may control the recharge rate based on prevailing conditions. In one embodiment, the capacitor 30 is recharged rapidly to restore readiness as soon as possible. In another embodiment, the capacitor 30 is recharged in stages, with current limited or spread over time to minimize new stress introduction into the system 10. The recharge sequence may also be deferred briefly if another startup event is anticipated, thereby aligning the capacitor state with expected demand.

Recharge itself can present a secondary demand on the energy source. So as to not destabilize the bus 80, the HEMS controller 22 may monitor system load while initiating recharge. If the active source is the grid 12, recharge can occur with minimal affect because of the grid's inherent stability. If the active source is the electric vehicle 40 or another distributed energy resource, recharge may be performed with greater moderation to stay within inverter or battery limits. In either case, the controller 22 governs recharge so that supply to the heavy load 72 and home loads 62 remains unaffected.

Once recharged, the capacitor 30 is restored to standby, ready to repeat the cycle for subsequent load activations. The operational states depicted in FIGS. 2 through 5 thus form a sequence: standby, pre-charge, startup support, and steady-state. The system 10 naturally cycles through these stages as individual heavy loads 72a, 72b, or others within panel 70 are requested to start. If multiple loads are queued, the HEMS controller 22 may sequence their startups so that capacitor recharge is complete or at least sufficient before the next activation is permitted.

The steady-state operation shown in FIG. 5 applies across a range of source configurations. In a grid-connected scenario, the capacitor 30 may recharge immediately and maintain readiness without affecting system operation. In a vehicle-to-home (V2H) implementation, recharge may be further coordinated with vehicle state-of-charge, user preferences, or programmed scheduling. In microgrid or hybrid systems, recharge may align with solar availability, generator status, or other distributed resources. By managing the capacitor 30 dynamically across these contexts, the home energy management system 20 maintains a reliable reserve for transient support without burdening steady-state operation.

As discussed, the HEMS controller 22 anticipates the demand associated with a forthcoming startup event by predicting the expected inrush energy. Rather than treating each heavy load 72 as identical, the controller 22 differentiates among them and estimates the magnitude and duration of current that will be required during the startup interval. This prediction forms the basis for determining how the flying capacitor 30 is charged and how startup requests are scheduled.

In one embodiment, the prediction is informed by a database of stored load profiles. During commissioning, or through automated device recognition, the system may catalog the loads present in the home energy system 10. Each entry in the database may include typical inrush characteristics, such as peak current expressed as a multiple of rated current (for example, 5-8×), expected duration of the surge (for example, 50 milliseconds to 2 seconds), and the associated energy demand (for example, 100-1000 joules). This data provides a first-order estimate that can be referenced when a startup request is received.

In another embodiment, the controller 22 references manufacturer specifications for connected appliances. Many appliances, such as air conditioning compressors, water pumps, or large kitchen equipment, are sold with published ratings that include startup current behavior. These specifications may be stored as lookup entries and accessed by the HEMS controller 22 to refine its predictions for particular load types.

The controller 22 may also refine its predictions through historical operation. As heavy loads 72 are repeatedly activated, the controller 22 records their actual startup current profiles. These measured events are stored and averaged, enabling the controller 22 to increase accuracy over time. For example, a motor load may consistently draw 450 joules during startup even if its catalogued profile listed 500 joules. Over time, the controller 22 adapts its predictions so that capacitor charging is aligned more closely with the observed behavior.

In some embodiments, the prediction is supplemented by real-time sensing. Immediately prior to startup, the HEMS controller 22 may measure electrical characteristics of the load circuit, such as impedance or instantaneous voltage and current. These parameters provide a dynamic indication of expected startup behavior. For example, the measured resistance of a motor winding may indicate whether the motor is starting cold or warm, allowing the controller 22 to adjust the predicted inrush energy accordingly.

Prediction may also incorporate user inputs or preferences. A mobile application or local panel interface may provide a mechanism for the user to specify prioritization rules or to identify certain loads as more important than others. In such cases, the controller 22 may bias its prediction and capacitor charging behavior toward those loads, ensuring they receive preference even when other requests are pending.

In general, the expected inrush energy may be determined based on at least one of: (i) stored load profiles, (ii) manufacturer specifications, (iii) historical operation data, (iv) real-time sensor feedback, or (v) user-defined prioritization settings. By using one or more of these inputs, the HEMS controller 22 develops a prediction that guides capacitor charging and sequencing decisions.

When multiple heavy loads 72a and 72b are present within the heavy loads panel 70, their requests for activation may occur simultaneously or in close succession. Without coordination, concurrent startups could impose overlapping inrush events that exceed the capacity of the source or the flying capacitor 30. To manage this condition, the HEMS controller 22 executes prioritization and sequencing logic.

Sequencing may be applied so that only one heavy load startup is granted at a time. When a request is received, the controller 22 evaluates the state of the system and may defer other requests until the initial startup has completed and the capacitor 30 has recharged to a sufficient level. This approach prevents the additive effect of overlapping inrush currents from destabilizing the bus 80 or overwhelming the active source.

Prioritization criteria may be established based on multiple factors. The controller 22 may consider the relative criticality of the loads, such as giving preference to climate control systems over discretionary appliances. It may also account for the available energy reserves of the system; for example, whether the source is operating near 90% of rated capacity or at a lighter load. The state of charge of the capacitor 30 may also influence the decision, as well as the specific load profile of the requested startup and general system stability considerations, such as the contribution of other distributed resources.

In one illustrative scenario, the HEMS power supply may already be operating at 90% of its rated capacity. If a motor load requests activation, the startup surge may temporarily increase demand to 110% of rated capacity for several milliseconds. This single event may be tolerated when supplemented by the flying capacitor 30. However, if two loads requested startup simultaneously, their combined inrush could push demand beyond 130% of rated capacity, potentially overwhelming the system 10. In such a case, the controller 22 would authorize one load immediately and defer the other until the capacitor 30 has recharged, such as after a delay of 10-20 seconds.

More generally, the HEMS controller 22 may prioritize and sequence activation of multiple loads based on at least one of load criticality, available energy reserves, capacitor charge state, expected load profile, or overall system stability. By coordinating startup requests according to these criteria, the system mitigates simultaneous inrush events and maintains reliable operation.

As discussed, once the HEMS controller 22 has determined the expected inrush energy for a forthcoming load, it initiates a charging process for the flying capacitor 30. The capacitor switch 32 is closed under control of the HEMS controller 22, connecting the capacitor 30 to the supply bus 80 so that energy may be accumulated from the active source. Unlike fixed pre-charge circuits that always prepare the capacitor to its maximum rating, the HEMS controller 22 establishes a target charge level that is matched to the predicted demand.

For example, if the predicted inrush demand corresponds to 500 joules, the capacitor 30 may be charged to a voltage corresponding to that energy level rather than an arbitrary maximum such as 1000 joules. In this way, charging is proportional to expected use. In other scenarios, the controller 22 may select a charge level that is a fraction of the capacitor's maximum capacity, such as 70-90 percent, when smaller startup events are expected. This tailored approach improves readiness by maintaining capacitor availability without unnecessarily drawing current from the source.

Charging logic may also include real-time adjustments. If the source condition changes during the charging process (for instance, if total system load rises unexpectedly) the controller 22 may pause or slow charging to prevent additional stress. A feedback loop confirms that the capacitor 30 has reached the intended voltage before authorizing startup. If the measured voltage is insufficient, the startup request may remain deferred until the capacitor 30 achieves the required state.

The charging and discharging of the capacitor 30 occurs in a dynamic environment. Loads may request activation while other appliances are operating, distributed resources may connect or disconnect, and environmental conditions may change. For this reason, the HEMS controller 22 may modify capacitor behavior in real time.

In one embodiment, the controller 22 evaluates total system demand and adjusts capacitor charging accordingly. For example, if the system 10 is already operating near 90 percent of rated power, the controller 22 may restrict the charging current to the capacitor 30 so as not to exceed the available margin. In another embodiment, the controller 22 may account for ambient temperature, recognizing that inverter components may be derated in high-temperature conditions and therefore limiting the magnitude of permitted inrush events.

The controller 22 may also anticipate future demand by analyzing queued startup requests. If two loads are pending, the controller 22 may charge the capacitor 30 to a level that satisfies the larger of the two requests or sequence them so that the capacitor 30 is prepared for each in turn. Recharge after one startup event may be slowed or staged if another request is expected shortly, thereby balancing readiness with system stability.

As discussed, the flying capacitor 30 may be incorporated into the HEMS 20 as illustrated in FIG. 1, where it is disposed within the HEMS housing 24 and managed by the HEMS controller 22. This placement situates the capacitor on the supply bus 80 between the active source (grid 12 or EV 40) and the downstream panels 60, 70 such that it acts as a buffer for startup events.

In other embodiments, the capacitor 30 may be located in different enclosures. For example, the capacitor 30 may be integrated into the EVSE 42, allowing it to be managed in conjunction with vehicle-to-home (V2H) operation. In another example, the capacitor 30 may reside within an inverter onboard the EV 40, where the vehicle controller coordinates its charging and discharge. Alternatively, a capacitor bank may be installed in a heavy load panel 70, configured to support loads 72 at the subpanel level. In each of these placements, the capacitor 30 may be managed by the HEMS controller 22 directly, or by distributed controllers that communicate over the control pathways.

The capacitor module itself may take several forms. For example, it may comprise a single capacitor element sized for the required energy level, a capacitor bank arranged in series or parallel, or a supercapacitor module capable of rapid charging and discharging. The energy storage capacity of the module may range from approximately 10 joules for smaller loads to 1000 joules or more for larger appliances, with recharge times ranging from less than one second to several tens of seconds depending on source capacity and load requirements.

The capacitor 30 may be coupled to the system bus 80 through a variety of switching devices. The capacitor switch 32 may be implemented as an electromechanical relay, a contactor, a solid-state device such as a MOSFET or IGBT, or a solid-state relay. In other embodiments, multiple switches may be used to control a bank of capacitors, enabling staged connection or selective configuration.

As discussed, in one set of embodiments, the primary source of power is an electric vehicle 40 coupled through EVSE 42. In this configuration, the flying capacitor 30 supplements the vehicle's traction battery and inverter output during load startups. Because the vehicle battery has finite energy capacity, the capacitor 30 provides a buffer that reduces the strain associated with high inrush currents.

The charging and discharging of the capacitor 30 may be adapted to the state of charge of the vehicle battery. For instance, if the state of charge is above a threshold level, such as 40 percent, the HEMS controller 22 may authorize startup events that utilize the capacitor 30. If the state of charge is low, the controller 22 may limit capacitor use or prioritize certain critical loads. User input through a mobile application may further refine these settings, such as by marking specific appliances as priority loads when the vehicle is supplying the home.

In some embodiments, the EV 40 may operate with grid-forming capabilities. In such a case, the flying capacitor 30 supplements the vehicle inverter by maintaining bus voltage stability during transients, thereby enabling smoother startup of heavy loads 72.

In some embodiments, the home energy system 10 operates locally under the control of the HEMS controller 22 without reliance on external communication. In other embodiments, the system 10 further includes a network interface that allows communication with external resources, including but not limited to remote servers, utility operator systems, mobile applications, or cloud-based platforms.

Cloud-based resources may support the predictive charging of the capacitor module 30. For example, one or more remote servers may maintain a library of load profiles that represent expected inrush characteristics for different appliances, machines, or devices. These profiles may be based on manufacturer specifications, standardized datasets, or aggregated field data. The HEMS controller 22 may access these profiles through the network interface and store them locally for use during startup prediction. Profiles may be periodically updated, allowing the system to maintain accuracy even as new appliances or load types are introduced.

In further embodiments, data collected from a plurality of home energy systems may be uploaded to a central server for fleet-level analysis. By aggregating startup traces and capacitor discharge events across many installations, the server can identify common patterns and refine the algorithms used to predict inrush demand. Updated models or parameter sets may then be distributed back to individual HEMS controllers 22.

Network connectivity may also enable interaction between the system and the user. For example, prioritization rules for heavy loads 72 may be entered through a mobile application, a web portal, or a networked home management interface. These preferences may specify which loads should be given startup priority, which may be deferred, or how startup behavior should vary under different conditions. The cloud platform may serve as the intermediary for synchronizing these settings across multiple user devices and the HEMS controller 22. In addition, the user may monitor capacitor charge state, load status, or historical activation data through such interfaces.

External coordination may also occur with utility operators or microgrid controllers. Signals transmitted through a cloud platform may include demand response events, requests to shed or defer load startups, or pricing information that affects when heavy loads are permitted to activate. The HEMS controller 22 may incorporate these external signals into its local decision-making, balancing user preferences with system-level coordination objectives.

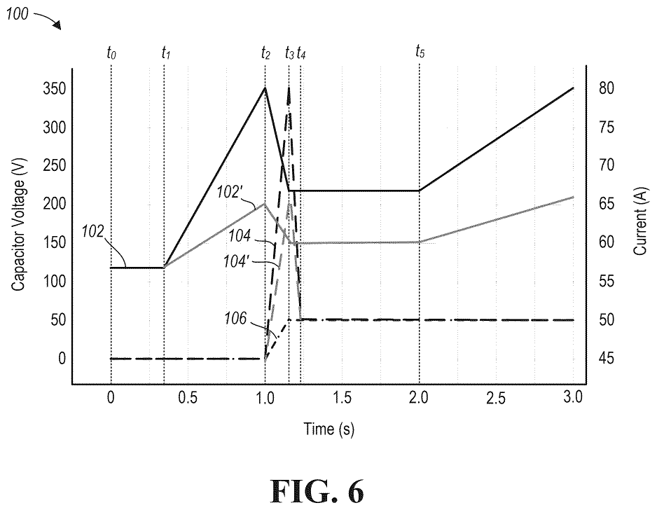

The network interface may further be used for diagnostics and system monitoring. Electrical traces similar to those illustrated in FIG. 6 may be uploaded for remote analysis, allowing detection of abnormal startup behaviors, capacitor degradation, or misalignment between predicted and observed inrush currents.

Thus, while the HEMS 20 may operate entirely through local control, embodiments including network or cloud connectivity may extend system capabilities by incorporating remote data sources, fleet-based analytics, user interaction through mobile or web interfaces, and coordination with external operators. The inclusion of these network-based functions may be implemented in whole or in part, with the core capacitor charging and sequencing functionality remaining under the control of the HEMS controller 22.

FIG. 6 illustrates a representative time-based chart 100 showing the operation of the home energy management system 20 during activation of a heavy load 72. The chart depicts capacitor voltage 102, load current 104, and source current 106 plotted over time. In this example embodiment, the system 10 executes a controlled charging and discharging sequence of the flying capacitor 30 under direction of the HEMS controller 22. The illustrated traces demonstrate the distinct operational phases of capacitor standby, pre-charging, discharge during load startup, decoupling, and recharge. Time markers t₀ through t₅ denote events within this cycle.

Between t₀ and t₁, the system 10 operates under steady-state conditions. The source, which may be either the utility grid 12 or the electric vehicle 40 depending on switch positions, delivers a base current of approximately 45 A, representing about 90% of the rated 50 A capacity of the supply. Home loads 62 are supported in this condition, while heavy loads 72 remain offline. The flying capacitor 30 remains at a standby voltage of about 120 V, and the capacitor switch 32 is open. The HEMS controller 22 monitors system conditions but does not actively engage the capacitor at this time.

At t₁, a startup request for the heavy load 72 is registered. The HEMS controller 22 determines that the upcoming inrush current may exceed the headroom available from the active source and therefore initiates a pre-charging sequence for the flying capacitor 30. Between t₁ and t₂, the capacitor switch 32 is closed and the capacitor 30 is charged from approximately 120 V to about 350 V, storing on the order of 500 J. This charge level is determined according to the controller's prediction logic, which may reference stored load profiles, historical operating data, or real-time sensing. The source current 106 remains steady near 45 A during this period, indicating that the pre-charge process is managed so as not to disturb upstream operation.

At t₂, the heavy load relay switch 54 is closed and the heavy load 72 begins startup. This produces a sharp inrush, with load current 104 rising rapidly to approximately 80 A at t₃, or about 160% of the rated steady-state value. To buffer this surge, the HEMS controller 22 simultaneously directs the capacitor switch 32 to close, causing the flying capacitor 30 to discharge into the bus 80. The capacitor voltage 102 drops from about 350 V to approximately 220 V over a brief interval corresponding to t₂ to t₃, reflecting the release of stored energy. This discharge supplements the source so that the upstream current 106 remains moderated at or near its rated 50 A rather than experiencing the full 80 A surge.

Between t₃ and t₄, the heavy load 72 transitions to steady-state operation. As the motor or other device increases and stabilizes, its current draw decreases from the inrush level to a sustained draw of about 50 A. The source 12 or 40 assumes this steady load, while the capacitor 30 is disconnected at approximately 220 V. The voltage of the bus 80 remains substantially stable throughout, preventing disruption to concurrent home loads 62. The capacitor 30 is effectively placed back into a standby state, ready for recharge when authorized by the controller 22.

At t₄, the system 10 has reached equilibrium with the heavy load 72 running at its steady-state demand. The source provides about 50 A, covering both the heavy load 72 and other base loads 62. The flying capacitor 30 remains decoupled and holds its residual charge near 220 V. No recharge has yet been commanded, and the capacitor 30 remains ready but idle. During this t₄ to t₅ interval, the HEMS controller 22 continues to monitor load conditions and capacitor state while preparing for either another load activation or a scheduled recharge sequence.

At t₅, the HEMS controller 22 initiates a controlled recharge of the flying capacitor 30. The capacitor voltage 102 ramps upward from approximately 220 V back toward the 350 V target level. The slope of this recharge is managed so as to limit additional burden on the source; for example, the controller 22 may select a staged or gradual current profile. Once restored to its nominal pre-charge level, the capacitor 30 is again available to support subsequent heavy load startups.

In addition to the initial load startup sequence represented by traces 102, 104, and 106, FIG. 6 also illustrates a subsequent load activation event shown by primed traces 102′ and 104′. This second cycle represents the case where the heavy load 72 expected to come online exhibits a lower anticipated inrush demand than the prior load. The HEMS controller 22 applies the same predictive process but establishes a reduced target charge level for the flying capacitor 30, resulting in lower capacitor voltage and a correspondingly smaller inrush current profile.

Prior to the second event, the capacitor module 30 is prepared through a controlled recharge process. Rather than restoring to the higher plateau of approximately 350 V achieved during the first event, the controller 22 sets a lower target of about 200 V, consistent with the reduced startup demand of the next scheduled load. This selective adjustment reflects the prediction logic, which may incorporate stored profiles or historical measurements indicating that the upcoming load requires less supplemental energy. Trace 102′ therefore illustrates the capacitor 30 charging to this lower level prior to activation of the subsequent load.

At the time of load initiation, the heavy load relay switch 54 is closed and the load 72 begins startup. As indicated by trace 104′, the inrush current rises to approximately 60 A, or about 120% of the rated steady-state current level, rather than the higher 80 A experienced during the first event. Simultaneously, the capacitor 30 discharges from the pre-charged level of about 200 V down toward 150 V, as shown by trace 102′. This energy release supplements the source 12 or 40 in a manner tailored to the reduced inrush requirement, so that the source current 106 remains moderated and does not exceed its rated capacity.

Following this moderated inrush, the load 72 transitions to its steady-state draw. The source resumes supplying approximately 50 A, consistent with its rated level, and the capacitor 30 is decoupled with a residual voltage near 150 V. The bus 80 remains stable throughout, ensuring that concurrent home loads 62 experience no disruption. The capacitor 30 thereby fulfills its role as a transient buffer for this smaller inrush cycle and is again placed into a standby state ready for recharge.

The chart of FIG. 6 therefore demonstrates three distinct electrical signatures associated with operation of the flying capacitor 30: a controlled charging ramp between t₁ and t₂, a rapid discharge to buffer the inrush event between t₂ and t₃, and a managed recharge cycle beginning at t₅. These signatures may serve as measurable fingerprints of system operation, observable in both capacitor voltage and supply current traces. The coordinated operation maintains continuity of power delivery to the home loads 62 while enabling reliable startup of heavy loads 72 without destabilizing the upstream source.

The first event (traces 102 and 104) and the adjusted subsequent event (traces 102′ and 104′) demonstrate the adaptability of the system 10. The HEMS controller 22 does not apply a fixed charge level or discharge pattern but instead scales the capacitor's operation to the predicted characteristics of each load startup. In this way, higher-demand loads are met with higher capacitor charge levels and larger discharge cycles, while lower-demand loads are served with proportionally smaller support. By charging only to the level needed for the expected inrush, the system minimizes unnecessary stress on the capacitor module 30 and reduces wasted energy, while still maintaining reliable startup assistance. FIG. 6 therefore illustrates not only the operation of the capacitor during a single activation event but also its repeatable adaptation across multiple activations, each with different inrush characteristics.

The algorithms, control strategies, or processes described herein may be executed by, or otherwise associated with, a computing element, controller, or processing device. Such computing elements can include dedicated electronic control units, programmable control modules, or distributed combinations thereof. Instructions for carrying out the disclosed operations may be embodied as software, firmware, or machine-executable code stored on one or more non-transitory computer-readable media. Examples of such media include, without limitation, permanent storage such as read-only memory devices, alterable storage such as random access memory devices or rewritable magnetic and optical media, or removable storage such as compact discs, flash drives, or memory cards. In certain embodiments, the disclosed operations may be realized in whole or in part by hardware elements, such as application-specific integrated circuits (ASICs), field-programmable gate arrays (FPGAs), logic arrays, or state machines. A given implementation may employ any combination of software instructions, firmware modules, or hardware components to achieve the functionality described.

The exemplary embodiments described above are provided for purposes of illustration and are not intended to exhaust the range of configurations that fall within the scope of the appended claims. Terminology used herein is descriptive in nature and should not be construed as limiting, except where explicitly recited in the claims. Functional roles ascribed to a “controller,” “processor,” or “module” may be performed by a single device or distributed across multiple devices in communication with one another. For example, the coordination of capacitor charging, load sequencing, and source interfacing may be executed by a single integrated controller or by a plurality of controllers configured to cooperate through standard communication techniques.

Features described with reference to one embodiment may be combined with features of other embodiments to yield further configurations, regardless of whether such combinations are explicitly illustrated or described. Although particular embodiments may be characterized in the foregoing description as providing certain operational benefits relative to other embodiments or known approaches, such descriptions are not intended to foreclose alternative implementations. A person of ordinary skill in the art will recognize that one or more desirable attributes may be balanced against others in order to achieve system-level objectives appropriate to a given application. Thus, embodiments that appear less optimal with respect to a given parameter may nonetheless fall within the scope of the present disclosure and may be advantageous in specific contexts.

What is claimed is:

1. A home energy system comprising:
a bus configured to distribute electrical energy to one or more loads;
a switch configured to selectively connect at least one load to the bus;
a capacitor module selectively connectable to the bus; and
a controller configured to charge the capacitor module to a target charge level, connect the capacitor module to the bus after charging the capacitor module to the target charge level, and configure the switch to connect the load to the bus with the capacitor module connected resulting in an inrush current to the bus, wherein the target charge level corresponds to a peak value of the inrush current such that as the peak value increases the target charge level increases.

2. The home energy system of claim 1, wherein the controller is configured to prioritize activation of loads based on at least one of load criticality, capacitor charge state, available source energy, or expected inrush current.

3. The home energy system of claim 1, further comprising an energy source selected from a utility grid, an electric vehicle, a photovoltaic system, a stationary battery, or a generator.

4. The home energy system of claim 3, wherein the energy source comprises an electric vehicle battery connected through electric vehicle supply equipment.

5. The home energy system of claim 1, wherein the switch is configured to selectively connect any of a plurality of loads to the bus.

6. The home energy system of claim 1, wherein the controller is configured to charge the capacitor module to a voltage less than a maximum voltage of the capacitor module based on an expected inrush current.

7. A home energy management system comprising:
a capacitor module configured to be connected to a bus; and
a controller configured to upon receiving a request to activate a load, charge the capacitor module to a target charge level based on an expected inrush current associated with the load, and connect the capacitor module to the bus when the load is activated to discharge stored energy from the capacitor module to the bus during startup of the load, wherein the target charge level corresponds to a capacitor voltage that supports an expected peak inrush current of the load.

8. The home energy management system of claim 7, wherein the controller determines the expected inrush current from at least one of a stored load profile, a historical record of prior load operation, a manufacturer specification, or real-time sensor feedback.

9. The home energy management system of claim 7, wherein the controller verifies a charge level of the capacitor module prior to authorizing activation of the load.

10. The home energy management system of claim 7, wherein the controller adjusts the target charge level of the capacitor module in real time based on system operating conditions.

11. The home energy management system of claim 7, wherein the capacitor module is positioned within a housing of the home energy management system or in an external enclosure.

12. The home energy management system of claim 7, wherein the controller is configured to disconnect the capacitor module from the bus after startup of the load.

13. The home energy management system of claim 7, wherein the controller is configured to recharge the capacitor module at a rate based on available source energy and a pending load request.

14. A method of operating a home energy management system, the method comprising:
charging, while a load is disconnected from a bus, a capacitor module to a target charge level corresponding to an expected peak inrush energy demand associated with the load;
after charging the capacitor module to the target charge level, coupling the capacitor module to the bus; and
coupling the load to the bus while the capacitor module remains coupled to the bus.

15. The method of claim 14, further comprising determining the expected peak inrush energy demand based on at least one of a stored load profile, historical startup data, or real-time sensing.

16. The method of claim 14, further comprising prioritizing activation of a plurality of loads based on at least one of load criticality, capacitor charge state, or available source energy.

17. The method of claim 14, further comprising charging the capacitor module to a level less than a maximum capacity of the capacitor module based on the expected peak inrush energy demand.

18. The method of claim 14, further comprising verifying that the capacitor module has achieved the target charge level prior to coupling the load to the bus.

19. The method of claim 14, further comprising adjusting the target charge level of the capacitor module based on a real-time system load condition.

20. The method of claim 14, further comprising coupling an electric vehicle battery to the bus and supplying electrical energy from the electric vehicle battery to charge the capacitor module while the capacitor module is coupled to the bus.
